(19) United States
(12) Patent Application Publication
(10) Pub. No.: US 2007/0295730 A1
(43) Pub. Date: Dec. 27, 2007

(54) Method For Obtaining A Hollow Monolithic Aluminum-Alloy Element With Handles, And Element Thus Obtained

(76) Inventor: Visino Marin, Casalmaggiore (IT)

Correspondence Address: Albert Josif;Modiano & Associati, Via Meravigli, 16, Milano, 20123, IT

(21) Appl. No.: 11/667,546

(22) PCT Filed: Nov. 14, 2005
(86) PCT No.: PCT/EP05/12174

§ 371 Date: May 11, 2007

(30) Foreign Application Priority Data
Nov. 18, 2004 (IT) MN2004A000032

(51) Int. Cl. B21D 53/00; A47J 36/02

(52) U.S. Cl. 220/573.1; 99/447

(57) ABSTRACT

A method for obtaining a hollow monolithic aluminum-alloy element provided with at least one handle, comprising: a first step for drawing an adapted portion of flat metal plate, obtaining a pre-deformed element which resembles, as regards the bottom and wall, the shape of the finished element and has, at the top of the wall, a protrusion at the at least one handle to be obtained; a second step for coining the pre-deformed element provided in the first step, obtaining an element which has a portion of a wall which is comprised between the at least one handle and the top of the wall.

### TECHNICAL FIELD

The present invention relates to a method for obtaining a hollow monolithic aluminum-alloy element with handles and to the element thus obtained.

### BACKGROUND

The great diffusion of aluminum-alloy containers for cooking is known; these containers must have grip handles so that they can be handled by users, and the same applies of course for the lids meant to cover said containers.

Containers with corresponding lids are currently commercially available in which the handles protrude monolithically at a certain distance from the top of the wall of said containers, and Italian patent application MN2003A000025 by the same Applicant indeed protects said containers and a method for obtaining them.

Continuing research, however, has allowed to devise a method which the present invention seeks to protect.

### DISCLOSURE OF THE INVENTION

The proposed aim is achieved by a method for obtaining a hollow monolithic aluminum-alloy element provided with handles according to the invention, characterized in that it comprises:
a first step for drawing a suitable portion of flat metal plate, obtaining a pre-deformed element which resembles, as regards the bottom and wall, the shape of the finished element and has, at the top of the wall, a protrusion at the at least one handle to be obtained;
a second step for coining the pre-deformed element provided in the first step, obtaining an element which has a portion of a wall which is comprised between the at least one handle and the top of said wall.

### BRIEF DESCRIPTION OF THE DRAWINGS

Further characteristics and advantages of the present invention will become better apparent from the description of a preferred but not exclusive embodiment thereof, illustrated by way of non-limiting example in the accompanying drawings, wherein:

FIG. 1 is a perspective view of a saucepan obtained with the method according to the invention;

FIGS. 2 and 3 are two sectional views, taken along mutually perpendicular planes, of the saucepan of FIG. 1;

FIG. 4 is a plan view of the initial portion of flat metal plate of the method;

FIG. 5 is a series of views, derived from the central image according to the arrows indicated therein, of the pre-deformed element obtained after the drawing step;

FIG. 6 is a view of the coining die in the open condition;

FIGS. 7 and 8 are two sectional views, taken along mutually perpendicular planes, of the coining die in the closed condition;

FIG. 9 is a view of the saucepan together with the corresponding lid.

### WAYS OF CARRYING OUT THE INVENTION

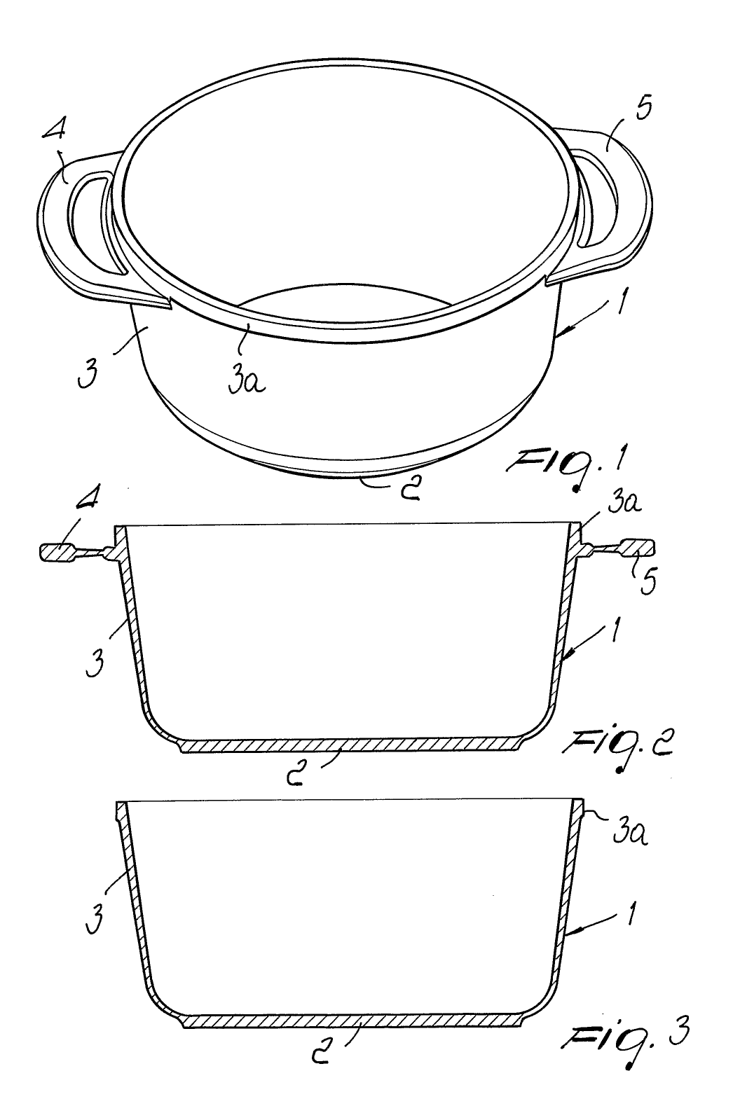

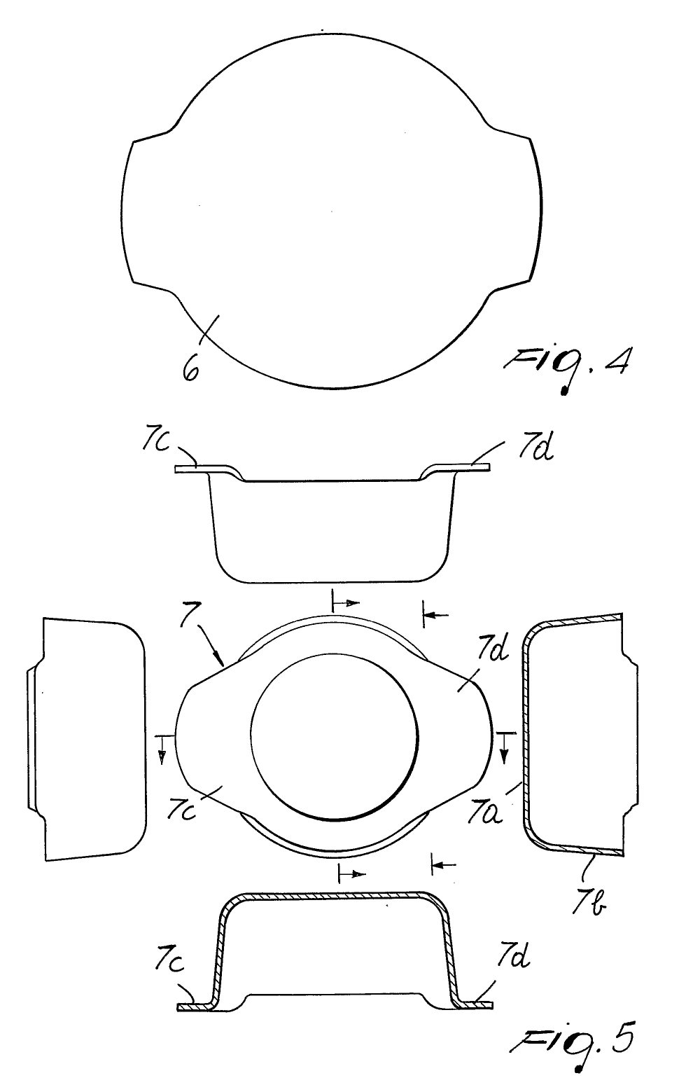

In FIGS. 1, 2 and 3, the reference numeral 1 designates a hollow monolithic element made of aluminum alloy which is shaped like a saucepan and comprises a bottom 2 and a wall 3; there are at least one and preferably two grip handles 4 and 5 which protrude monolithically from the wall 3 at a certain distance from the top, and the wall portion comprised between said handles and said top is shaped like a raised rim 3a.

A method according to the invention for obtaining the saucepan described above starts from the portion of flat metal plate, which is appropriately pre-shaped and indicated by the reference numeral 6 in FIG. 4.

In the first step of the method, the portion of metal plate 6 is subjected to drawing in a normal die, obtaining a pre-deformed element designated by the reference numeral 7 in FIG. 5.

This element resembles, as regards the bottom 7a and the wall 7b, the shape of the saucepan 1, and has, at the top of the wall 7b, at least one and preferably two protrusions 7c and 7d at the at least one handle to be obtained.

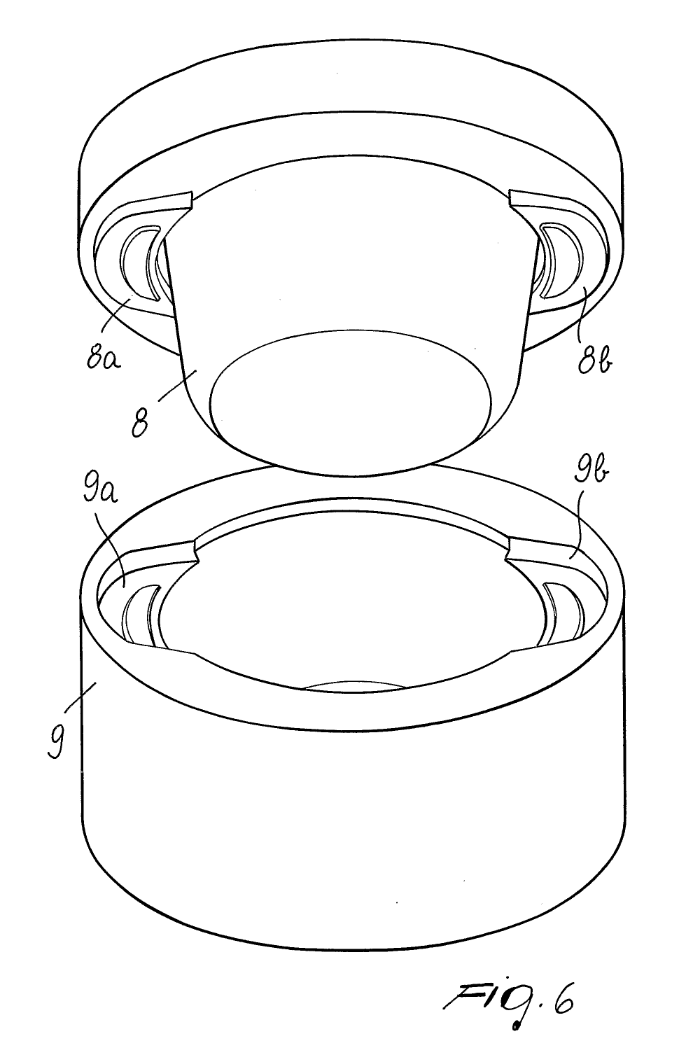

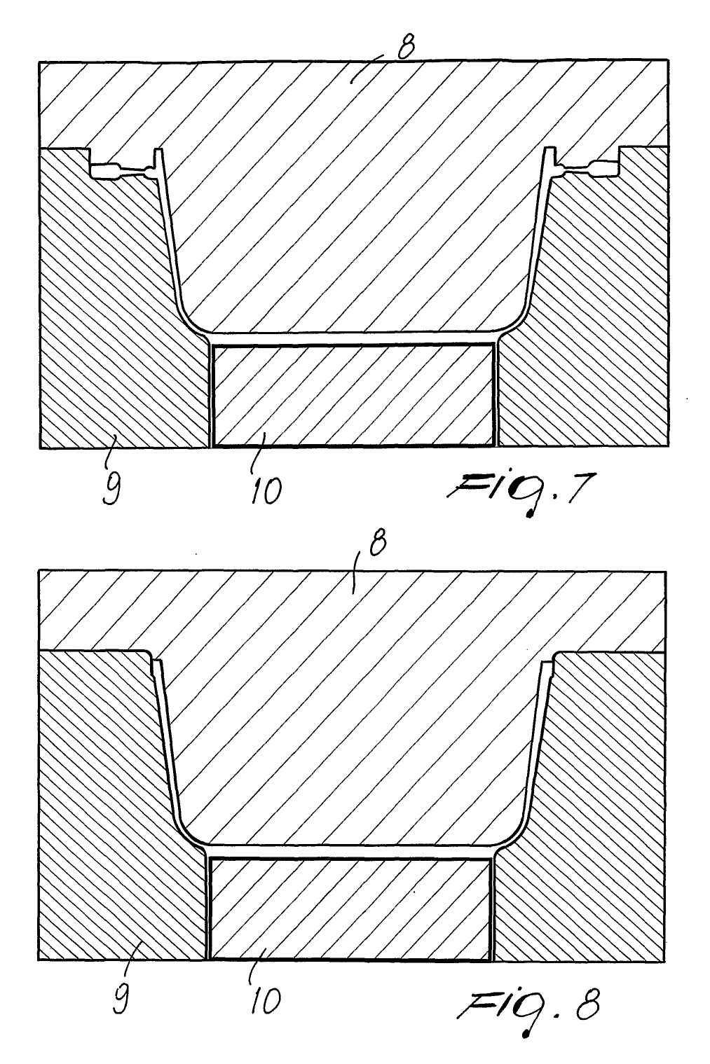

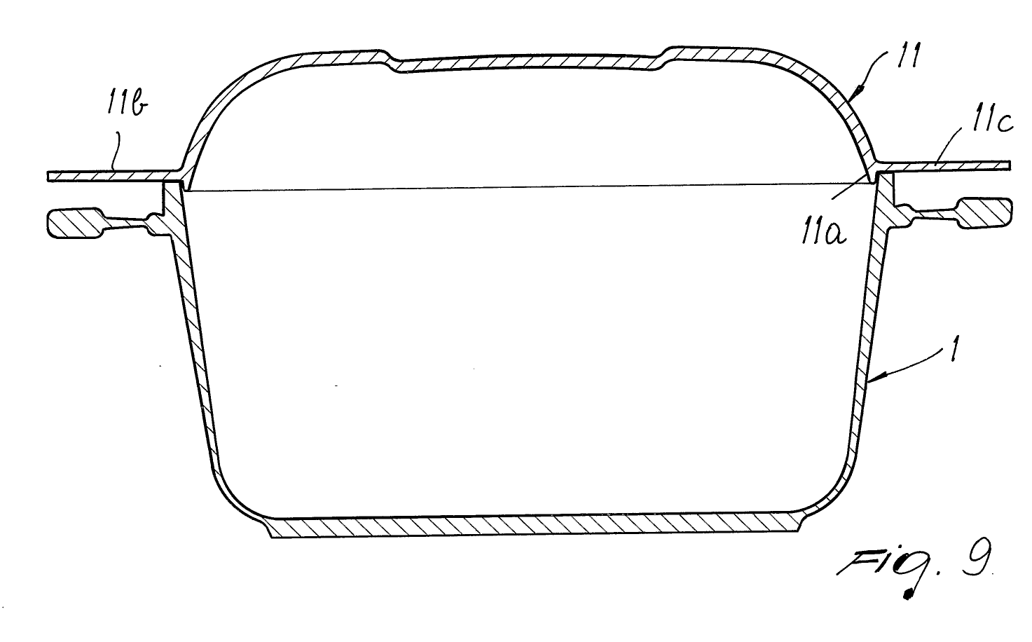

The pre-deformed element 7 is then inserted, during the second step of the method, in the coining die shown in FIGS. 6, 7 and 8, which comprises the male plug 8, the female part 9 and the disk 10, according to an obvious arrangement which provides for the insertion of the protrusions 7c, 7d within the cavities 9a, 9b which are present in the female part 9 and are matched by the protrusions 8a, 8b provided in the male plug 8.

The coining performed in the described die produces the element designated by the reference numeral 1.

To complete what has been described above, attention is called in FIG. 9 to the coupling between the saucepan 1 and the corresponding lid 11, which is also made with the method described above; the correctness of the mating is ensured by the reference border 11a according to which the wall portion comprised between the handles 11b, 11c and the top is configured.

The described invention is susceptible of numerous modifications and variations, all of which are within the scope of the appended claims; all the details may further be replaced with other technically equivalent elements.

The disclosures in Italian Patent Application No. MN2004A000032 from which this application claims priority are incorporated herein by reference.

What is claimed is:

1-4. (canceled)

5. A method for obtaining a hollow monolithic aluminum-alloy element provided with at least one handle, comprising:
a first step for drawing a suitable portion of flat metal plate, obtaining a pre-deformed element which resembles, as regards the bottom and wall, the shape of the finished element and has, at the top of the wall, a protrusion at the at least one handle to be obtained;
a second step for coining the pre-deformed element provided in the first step, obtaining an element which has a portion of a wall which is comprised between the at least one handle and the top of said wall.

6. The method according to claim 5, wherein the portion of flat metal plate that is subjected to drawing is pre-shaped.

7. An element obtained by means of the method according to claim 5, wherein the portion of wall which is comprised between the at least one handle and the top has the shape of a raised rim.

8. The element according to claim 7, wherein the wall portion comprised between the at least one handle and the top has the shape of a border for reference in the coupling of said element to a complementarily shaped element.
